(19) United States
(12) Patent Application Publication
(10) Pub. No.: US 2009/0304317 A1
(43) Pub. Date: Dec. 10, 2009

(54) BEARING CAGE

(75) Inventor: Rainer Schroeder, Egenhausen (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/293,928

(22) PCT Filed: Mar. 14, 2007
(86) PCT No.: PCT/DE07/00460

§ 371 Date: Oct. 24, 2008

(30) Foreign Application Priority Data
Mar. 23, 2006 (DE) 10 2006 013 430.3

(51) Int. Cl. F16C 19/00; F16C 33/46; B21D 53/10

(52) U.S. Cl. 384/445; 384/578; 29/898.061

(57) ABSTRACT

Bearing cage, in particular for rolling bearings, with a first cage portion and a second cage portion. According to the invention, the first cage portion has at least one first engagement element, and the second cage portion has at least one second engagement element, and these engagement elements can be brought into engagement with one another by means of a relative movement of the first cage portion with respect to the second cage portion in such a way that an at least form-fit connection is established between the first cage portion and the second cage portion.

### FIELD OF THE INVENTION

The present invention relates to a bearing cage. The invention is described with reference to a cage for a cylindrical roller bearing, but reference is made to the fact that the bearing cage according to the invention can also be used for other bearing types such as spherical roller bearings or self aligning roller bearings.

Bearing cages are known from the prior art which are composed of two or more cage parts and which are assembled during mounting. Here, different variants of cages of this type having two parts or more are known.

One possibility which is known from the prior art comprises providing a solid cage which comprises a cage comb and a cage cover. Here, the cover is heat riveted by way of rivets which are produced on the cage comb. This operation is carried out on the bearing which has already been mounted in the finished position. One disadvantage of this variant consists in the fact that the manufacturing costs are relatively high. In addition, as has been mentioned, cage mounting on the mounted bearing is necessary in this case. In addition, tearing off of the respective rivet connections can occur, as a result of which the service life of the cage is impaired.

A further possibility which is known from the prior art comprises configuring the cage as a solid cage with a window contour which is milled in. In this embodiment, the cage window is made from the outside by way of a contour cutter or an end milling cutter. In this solution, the cutter therefore has to mill in all the windows individually one after another. In addition, undercuts which in some circumstances weaken the cage side edge have to be milled in at the four corners of the windows. This variant therefore entails lengthy machining.

Furthermore, it is known to provide solid cages, for example for spherical roller bearings, two cage halves being connected to one another by way of rivets in this embodiment. To this end, the cage halves have to be paired to one another and drilled. The rivet hole which is drilled through the webs must not impair the strength of the web. In order to achieve this, the webs are of comparatively thick configuration, which leads to minimized circumferential loading. In addition, this type of cage is relatively expensive to manufacture and can withstand only comparatively low load ratings.

Furthermore, solid cages for split self aligning roller bearings are known from the prior art, a cage cover being screwed onto the webs of the cage comb by way of self-tapping screws. Here, too, there is the problem of high manufacturing costs and, furthermore, there is the problem that the self-tapping screws can shear off in operation.

The present invention is therefore based on the object of providing a bearing cage which can be manufactured inexpensively and comparatively quickly. In addition, simple mounting of the bearing cage and also safe and simple handling during mounting of the rolling bodies is to be made possible. This is achieved according to the invention by a bearing cage as claimed in claim 1 and a mounting method as claimed in claim 11. Advantageous embodiments and developments are the subject matter of the subclaims.

The bearing cage according to the invention, in particular for an antifriction bearing, has a first cage section and a second cage section. According to the invention, the first cage section has at least one first engagement element and the second cage section has at least one second engagement element. Said engagement elements can be brought into engagement with one another by a relative movement of the first cage section with respect to the second cage section, in such a way that an at least positive connection is produced between the first cage section and the second cage section.

Cage sections are understood to mean sections which result in the complete bearing cage when assembled. The positive connection between the first cage section and the second cage section achieves a situation where the two cage sections cannot be separated from one another directly, in particular in the longitudinal direction of the cage, that is to say without further movement processes taking place in between.

The first engagement element and the second engagement element are preferably constructed in such a way that the positive connection between the first cage section and the second cage section is achieved by rotation of one cage section about a longitudinal axis of the cage. This means that one cage section is rotated relative to the other cage section with respect to the longitudinal axis of the cage. This rotation produces the engagement between the engagement elements and therefore prevents the two cage sections being separated from one another by the action of force in the longitudinal direction of the bearing cage. As a result of this arrangement of the engagement elements, further connecting elements such as rivet connections or screw connections which entail the above-described problems in the prior art are rendered superfluous.

In a further preferred embodiment, the bearing cage has two cage rims and a multiplicity of webs which extend between said rims, at least one engagement element being arranged in a web section of said webs. This means that the engagement between the cage sections is arranged via at least one web section. All the engagement elements are preferably provided in the respective web sections of the webs. This means that one cage section has a multiplicity of first web sections and the second cage section has a multiplicity of second web sections, and the engagement is brought about via these respective first and second web sections.

All the web elements preferably have at least one engagement element each. This means that a multiplicity of positive connections are produced between the individual web sections and in this way the stability of the overall bearing cage is increased.

In a further advantageous embodiment, the engagement elements are projections and grooves which engage into one another and are arranged in the web sections. This engagement of the grooves and projections into one another achieves a situation where a displacement of the web sections with respect to one another in the longitudinal direction of the bearing cage is no longer possible.

All the grooves of a web section preferably have substantially the same profile. In this way, simple manufacturing of the corresponding cage section is possible, for example, by turning. A further advantage lies in the fact that each first web section can be connected to any desired second web section and therefore a plurality of rotary positions are possible, in which the cage sections can be fastened to one another. The grooves can have different geometric cross sections, such as, in particular, but not exclusively, circular cross sections, polygonal cross sections, ellipsoidal cross sections, combinations thereof and the like.

In a further preferred embodiment, the grooves have a cross section which is constant in the circumferential direction of the bearing cage. In this way, it is possible in a particularly advantageous way to turn one cage section with respect to the other. However, it would also be possible for individual grooves or all the grooves to taper in the circumferential direction of the bearing cage. As a result, also a force-lock connection of the two cage sections could be achieved by rotation of one cage section with respect to the other.

The bearing cage is preferably manufactured from a material which is selected from a group of materials which comprises brass, steel, lightweight metal, for example aluminum, combinations thereof and the like.

Furthermore, the present invention is directed to an antifriction bearing having a bearing cage of the above-described type.

Furthermore, the present invention is directed to a method for mounting an antifriction bearing, a first cage section being arranged in one method step and a second cage section being connected to the first cage section in a further method step. According to the invention, the second cage section is connected to the first cage section by a rotational movement with regard to a longitudinal axis of the bearing.

The cage sections are preferably oriented with respect to one another in a further method step. This orientation preferably takes place after the connection of the second cage section to the first cage section. The orientation achieves a situation where the individual webs extend substantially rectilinearly.

A multiplicity of rolling bodies are preferably introduced into the cage after the connection of the cage sections. The rolling bodies are preferably snapped into pockets of the cage, it being possible for this to take place both from the inside and from the outside with regard to the cage depending on the mounting sequence.

Further advantages and embodiments result from the appended drawings, in which:

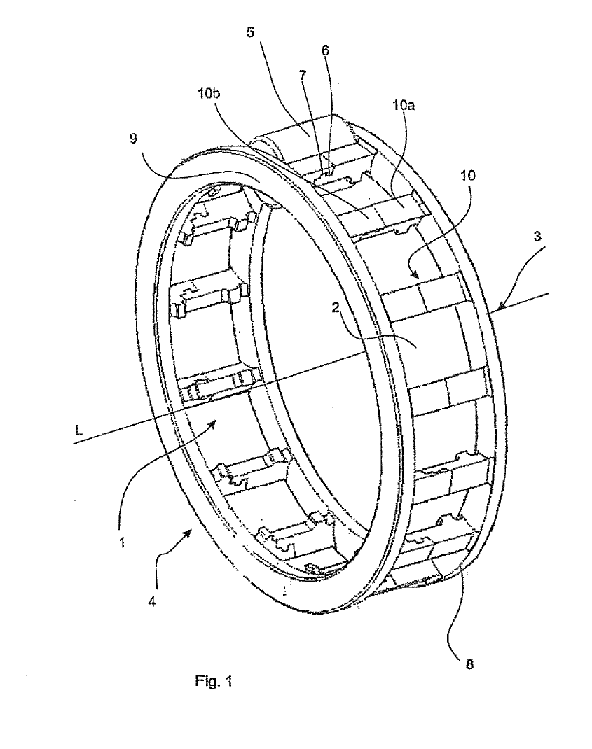

FIG. 1 shows a perspective view of a bearing cage according to the invention;

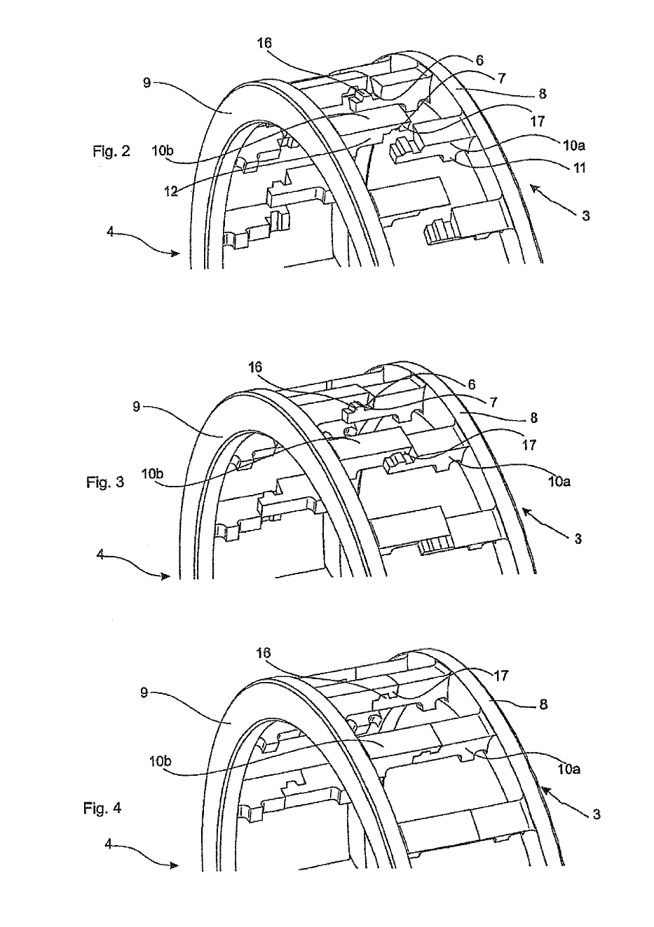

FIG. 2 shows a partial illustration of the bearing cage in order to show the mounting method;

FIG. 3 shows a further partial illustration in order to show the mounting method;

FIG. 4 shows a further partial illustration in order to show the mounting method;

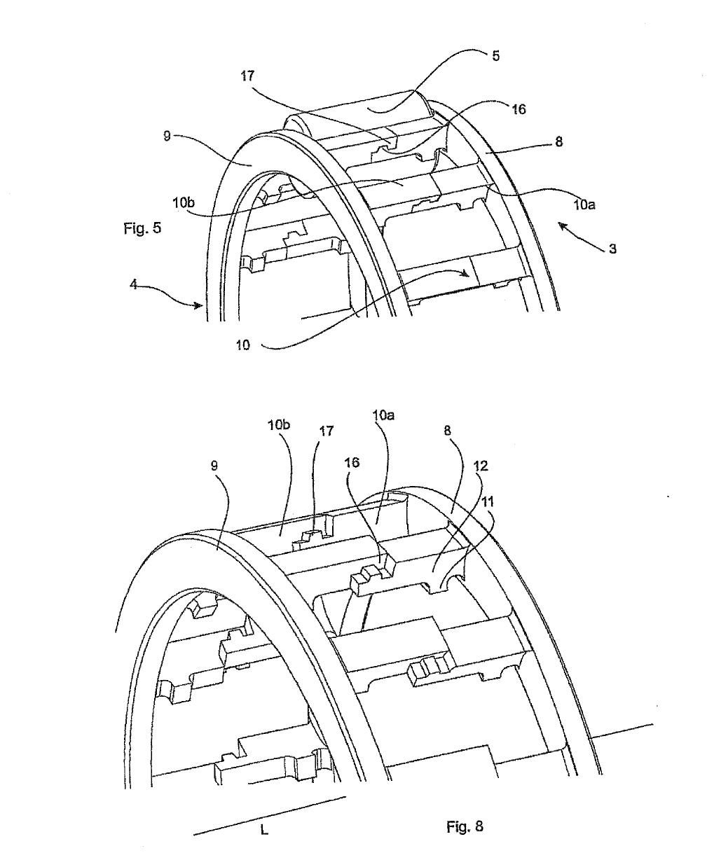

FIG. 5 shows a further partial illustration in order to show the mounting method;

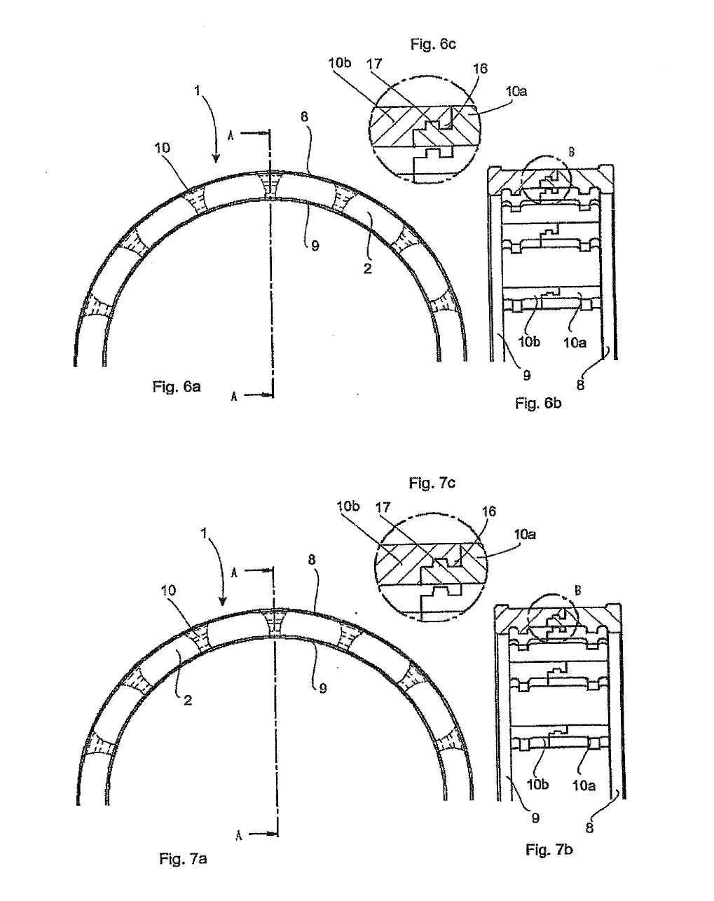

FIG. 6a shows a schematic top view of a bearing cage according to the invention;

FIG. 6b shows a side view of the bearing cage along the line A-A from FIG. 6a;

FIG. 6c shows an illustration of a detail from FIG. 6b;

FIG. 7a shows a top view of the bearing cage according to the invention;

FIG. 7b shows a side view of the bearing cage along the line A-A from FIG. 7a;

FIG. 7c shows an illustration of a detail from FIG. 7b; and

FIG. 8 shows an oblique view of a bearing cage according to the invention in a further embodiment.

FIG. 1 shows a bearing cage 1 according to the invention in a first embodiment. Said bearing cage has a first rim 8 and a second rim 9. In this embodiment, these rims are substantially circular and a multiplicity of webs 10 extend in a longitudinal direction L of the bearing cage between the rims 8, 9. In each case cage pockets 2 for rolling bodies 5 are formed by the rims 8, 9 and the webs 10. The first cage section 3 comprises the rim 8 and web sections 10a which extend from said rim 8 in the longitudinal direction L of the bearing cage. The second cage section 4 has a rim 9 and web sections 10b which likewise extend from said rim 9 in the longitudinal direction L of the bearing.

The respective web sections 10a and 10b each have grooves 6, 7 and projections 16, 17 which can be brought into engagement with one another, in order to assemble the bearing cage 1. To be more precise, the projection 16 of the web section 10a is in engagement with the groove 7 of the web section 10b and the projection 17 of the web section 10b is in engagement with the groove 6 of the web section 10a.

The projections 16 preferably extend in a predefined direction, here radially to the outside, for example, and the projections 17 extend in an opposite direction to the former, that is to say substantially radially to the inside. The grooves 6, 7 also extend in opposite directions in relation to one another.

FIGS. 2-5 show the manufacturing method for the bearing cage according to the invention. In FIG. 2, the first cage section 3 and the second cage section 4 can be seen, said cage sections 3 and 4 being offset with respect to one another in the rotational direction. This means that the web sections 10a and 10b of the two cage sections 3 and 4 are not yet in engagement with one another. At the same time, the groove 6 of the first cage section 3 and the groove 7 of the second cage section 4 can be seen. As has been said, in each case projections 16 and 17 of the respectively other cage section engage into said two grooves 6, 7. It can be seen that the respective projections 16 and 17 and also the corresponding grooves 6, 7 have a substantially constant width in the circumferential direction of the respective cage sections 3, 4.

The respective cage sections 3 and 4, which can also be denoted as cage comb and cage cover, or their basic contours can be manufactured in each case by turning. The illustrated grooves 6, 7 which engage into one another can also be manufactured in a turning process. As a result, the manufacture is simplified to a great extent overall.

FIG. 3 shows a further method step in the manufacture of the bearing cage. Here, the two cage sections 3, 4 are hooked into one another, that is to say the respective projections 16, 17 engage into the grooves 6, 7. Here, the groove diameters and their widths are adapted in such a way that there is only a small play between the two cage sections 3, 4.

In a further method step which is shown in FIG. 4, the two cage sections 3, 4 are oriented with respect to one another. This means that the orientation achieves a situation where the web sections 10a and 10b of the cage sections 3, 4 merge into one another substantially without edges. In this way, bearing faces 12 for the rolling bodies which are to be inserted are formed. Said bearing faces 12 have a cylinder segment shaped profile. In addition, the bearing faces 12 have holding lugs 11 which achieve at least temporary holding of the rolling bodies which are to be inserted.

In the embodiment which is shown in FIG. 4, the web sections 10a and 10b are substantially equally long. This means that the region in which the engagement takes place is situated substantially symmetrically in the center of the bearing cage. This is advantageous but not obligatory.

In the method section which is shown in FIG. 5, the rolling body 5 is inserted, that is to say is pressed in from the inside in this case. In general, after the orientation of the cage sections, the rolling bodies or rollers 5 can be snapped into the preferably drilled or milled cage pockets 2 from the outside or inside. After the mounting of the rolling bodies 5, the two cage sections can no longer be separated from one another, since the rolling bodies 5 prevent the two cage sections 3, 4 from rotating with respect to one another.

As explained above, a separation of the two cage sections 3, 4 in the longitudinal direction of the webs is prevented by the respective grooves 6, 7 and projections 16, 17. In the solution which is shown, the riveting, screwing or the complicated milling of the window pockets can be omitted.

FIG. 6a shows a top view of a bearing cage 1 according to the invention. It can be seen that said bearing cage 1 has a multiplicity of webs 10 and cage pockets 2, in which the rolling bodies are arranged. FIG. 6b shows a side view of the bearing cage from FIG. 6a. This embodiment is, as explained above, a substantially symmetrically constructed element, that is to say the web sections 10a and 10b extend between the two rims 8 and 9 with a substantially equal length in the longitudinal direction L of the bearing cage 1.

FIG. 6c shows an illustration of a detail of the section B from FIG. 6b. It can be seen that the grooves and projections have a substantially rectangular profile.

FIGS. 7a-7c show a further embodiment of a bearing cage according to the invention. The essential difference between the embodiment which is shown in FIGS. 6a-c and the embodiment which is shown in FIGS. 7a-c comprises the shape of the grooves 6, 7 and of the projections 16, 17. In the embodiment which is shown in FIGS. 7a-7c, the grooves are not of rectangular design but rather of slightly V-shaped design. However, it would also be possible here to position the sections of the respective grooves to be even more oblique. A person skilled in the art also sees that other types of grooves can be provided, such as grooves having circular segment shaped profiles and the like.

FIG. 8 shows an oblique view of the bearing cage which is shown in FIGS. 7a-7c. In this case, the projections 16, 17 are configured in such a way that they can engage into the respectively V-shaped grooves 6, 7. A person skilled in the art sees that other designs of the grooves and engagement elements are also possible, without departing from the scope of the invention as a result.

All of the features which are disclosed in the application documents are claimed as being essential to the invention, in so far as they are novel over the prior art individually or in combination.

### LIST OF DESIGNATIONS

1 Bearing cage
2 Cage pockets
3 First cage section
4 Second cage section
5 Rolling bodies
6, 7 Grooves
8 First rim
9 Second rim
10 Webs
10a, 10b Web sections
11 Holding lug
12 Bearing face
16, 17 Projections
L Longitudinal direction

1. A bearing cage, comprising: a first cage section and a second cage section, wherein the first cage section has at least one first engagement element and the second cage section has at least one second engagement element, and said engagement elements can be brought into engagement with one another by a relative movement of the first cage section with respect to the second cage section, in such a way that an at least positive connection is produced between the first cage section and the second cage section.

2. The bearing cage as claimed in claim 1, wherein the first engagement element and the second engagement element are provided in such a way that the positive connection between the first cage section and the second cage section is achieved by rotation of one cage section about a longitudinal axis of the cage.

3. The bearing cage as claimed in claim 1, the bearing cage has two cage rims and a multiplicity of webs which extend between said rims, at least one engagement element being arranged in a web section of said webs.

4. The bearing cage as claimed in claim 3, wherein all the engagement elements are provided in the web sections of the webs.

5. The bearing cage as claimed in claim 3, wherein all the web sections have at least one engagement element each.

6. The bearing cage as claimed in claim 1, wherein the engagement elements are projections and grooves which engage into one another and are arranged in the web sections.

7. The bearing cage as claimed in claim 6, wherein all the grooves of a web section have substantially the same profile.

8. The bearing cage as claimed in claim 6, wherein the grooves have a cross section which is constant in the circumferential direction of the bearing cage.

9. The bearing cage as claimed in claim 1, wherein the bearing cage is manufactured from a material which is selected from a group of materials which comprises brass, steel, lightweight metal, in particular aluminum, combinations thereof and the like.

10. An antifriction bearing having a bearing cage as claimed in claim 1.

11. A method for mounting an antifriction bearing comprising the following steps:
arrangement of a first cage section,
connection of a second cage section to the first cage section, wherein the second cage section is connected to the first cage section by a rotational movement with regard to a longitudinal axis of the bearing.

12. The method as claimed in claim 11, wherein the cage sections are oriented with respect to one another in a further method step.

13. The method as claimed in claim 11, wherein a multiplicity of rolling bodies are introduced into the cage after the connection of the cage sections.
